(19) United States
(12) Patent Application Publication
(10) Pub. No.: US 2019/0275720 A1
(43) Pub. Date: Sep. 12, 2019

(54) 3D PRINTING OF FIBROUS STRUCTURES

(71) Applicant: NORTH CAROLINA STATE UNIVERSITY, Raleigh, NC (US)

(72) Inventors: Behnam POURDEYHIMI, Raleigh, NC (US); Benoit MAZE, Raleigh, NC (US); Bruce ANDERSON, Raleigh, NC (US)

(21) Appl. No.: 16/345,513

(22) PCT Filed: Oct. 27, 2017
(86) PCT No.: PCT/US2017/058750

§ 371 Date: Apr. 26, 2019

Related U.S. Application Data
(60) Provisional application No. 62/413,891, filed on Oct. 27, 2016.

(51) Int. Cl. B29C 48/285; B29C 70/24

(52) U.S. Cl. CPC B29C 48/2886; B33Y 10/00; B29C 70/24

(57) ABSTRACT

Methods and apparatuses for printing a three-dimensional fibrous structure are disclosed. A fibrous layer is printed onto a printing surface by forcing fibers through at least one extrusion die and onto the printing surface. The extrusion die and/or printing surface are moved in the X, Y, and/or Z direction while printing the fibers.

### CROSS REFERENCE TO RELATED APPLICATIONS

This application claims the benefit of priority to U.S. Provisional Application 62/413,891, filed Oct. 27, 2016, which is incorporated by reference herein in its entirety.

### FIELD

The subject matter disclosed herein relates generally to the field of 3D printing. More specifically, the disclosed subject matter relates to methods and apparatuses for preparing fibrous structures, e.g., textile parts or biomaterials, with 3D printing technology.

### BACKGROUND

Biomaterials have been used in medicine for many years; sutures, skin grafts, vascular grafts, and other forms are already available. In the last few decades, biosystems are being designed to interact with physiological systems, stimulate specific cell responses at molecular level, and direct proliferation, differentiation, and organization (John Fischer, NSF Workshop on Additive Manufacturing, Arlington, Va., May 17-18 2016). Additionally, biomaterials are often woven, knitted, nonwoven, layered, sometimes molded and shaped to mimic macro-, meso-, and micro-architectural cues of the tissue they are intended to replace. Among many available approaches to such biomaterials, electrospinning has become the standard for the formation of tissue engineered substrates for bioprinting because it is simple to set up. However, it is slow and not a system that can be scaled up easily with little or no control over the structure as it is a recipe-driven system. Other processes like phase separation, have also been used with limited success.

The key to overcoming these barriers is to control porosity and uniformity, and in some instances, the directionality of pores and/or the fibers—a requirement for mass customization. Absolute control over solidity and fiber size and fiber network orientation are also important. In the current systems, this control is lacking and customized solutions are hard to achieve. For instance, controlling the fiber orientation distribution in a multi-layered structure is difficult to achieve today. Also, protein inclusion and controlled delivery is an important element in bioprinting, but challenging to put into practice (A J Melchiorri, et al., Adv Healthcare Mater 5:319-325 (2015)).

Common strategies towards preparing biomaterials have included inkjet bioprinting, extrusion-based bioprinting, and stereolithography (Mota et al., J Tissue Eng Regen Med 2015). Extrusion bioprinting today is limited to thermoplastic materials such as PCL, PLLA, PGA, etc. Solution-based systems, such as electrospinning, offer a much broader range of possibilities in terms of materials, and the incorporation of specific biomimetic gradient within the biomaterial, but are limited in terms of their scalability and control. What are thus needed are methods and systems that would permit mass customization of fibrous structures—methods and systems that provide control over scaffold geometry, using materials with complex composition. What are also needed are methods and systems that permit patterning and spatial localization of cells within a fibrous structure. The methods and systems disclosed herein address these and other needs.

### SUMMARY

In accordance with the purposes of the disclosed methods and systems, as embodied and broadly described herein, the disclosed subject matter related to methods and systems for producing fibrous structures. Articles of the produced fibrous structures are also disclosed.

In certain aspects, disclosed herein is a method for printing a three-dimensional fibrous structure, comprising: printing a fibrous layer onto a printing surface by forcing fibers through at least one extrusion die and onto the printing surface, wherein the extrusion die and/or printing surface are moved in the X, Y, and/or Z direction while printing the fibers.

In certain aspects, disclosed herein is an apparatus for printing a three-dimensional fibrous structure, comprising: an extrusion unit comprising at least one extrusion die; a printing platform; an X-Y-Z movement system configured to move the at least one extrusion die and/or the printing platform in a three coordinate system; and at least one computer communicatively coupled with the X-Y-Z movement system, the at least one computer programmed to receive three-dimensional print type inputs for a structure to be three-dimensionally printed and to control the X-Y-Z movement system and extrusion unit.

Additional advantages will be set forth in part in the description that follows or may be learned by practice of the aspects described below. The advantages described below will be realized and attained by elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 is a photograph of an X-Y-Z movement system, printing platform, and extrusion unit.

FIG. 2 is a close up view of the extrusion unit.

FIG. 3 is a close up view of the fibrous structure being printed on the printing platform.

FIG. 4 is a side view of a schematic layout.

FIG. 5 is an enlarged view of the multi-head die assembly;

FIG. 6 is an enlarged view of the 3 possible collection systems.

FIG. 7 is a detailed view of a printing head with coaxial particle feed.

FIG. 8 shows some exemplar webs created with a prototype system.

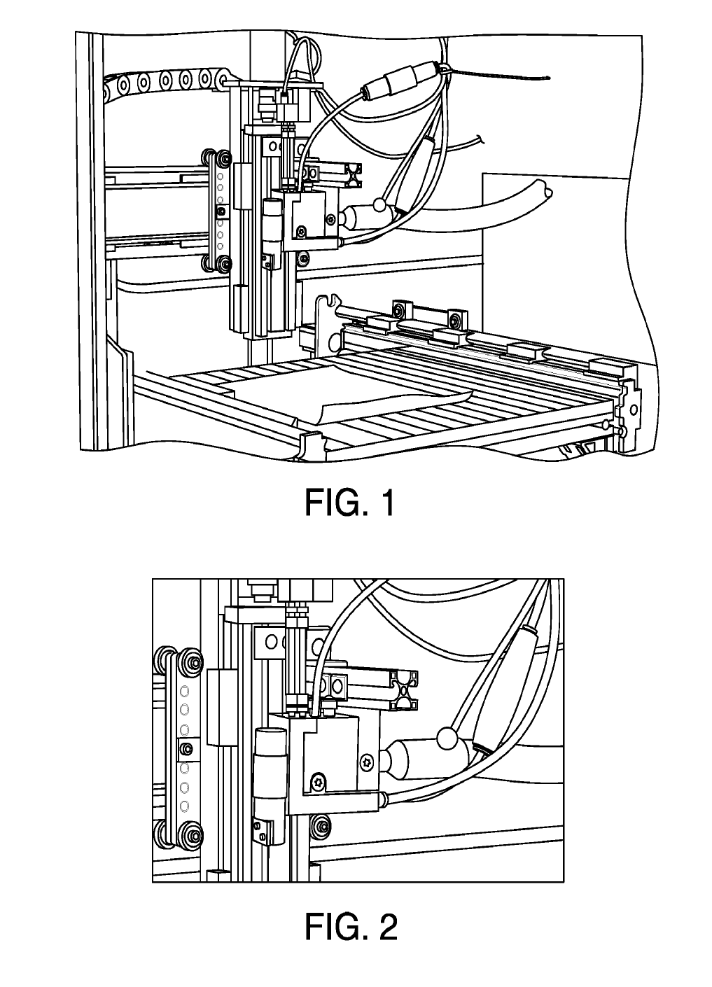

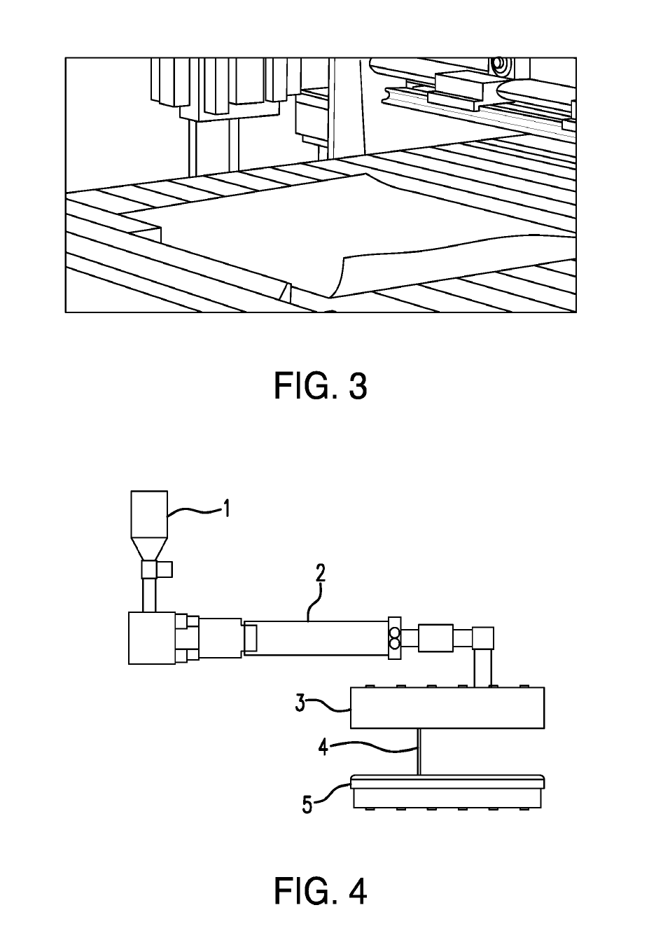

### DETAILED DESCRIPTION

The methods and systems described herein may be understood more readily by reference to the following detailed description of specific aspects of the disclosed subject matter and the Examples included therein.

Before the present methods and systems are disclosed and described, it is to be understood that the aspects described below are not limited to specific methods or specific systems, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the fiber” includes mixtures of two or more such fiber, reference to “an agent” includes mixture of two or more such agents, and the like.

“Biocompatible,” as used herein, refers to the property of being biologically compatible with a living being by not causing harm.

“Biomaterial,” as used herein, includes plant or animal derived tissues. In preferred embodiments, the biomaterial is animal derived cortical bone, cancellous bone, connective tissue, tendon, pericardium, dermis, cornea, dura matter, fascia, heart valve, ligament, capsular graft, cartilage, collagen, nerve, placental tissue, and combinations thereof. In some embodiments, the biomaterial-based implants are formed from demineralized bone matrix (DBM) material.

A “nonwoven fabric” means a fabric having a structure of individual fibers or filaments that are interlaid but not necessarily in an identifiable manner as with knitted or woven fabrics.

“Optional” or “optionally” means that the subsequently described event or circumstance can or cannot occur, and that the description includes instances where the event or circumstance occurs and instances where it does not.

It is understood that throughout this specification, the identifiers “first” and “second” are used solely to aid in distinguishing the various components and steps of the disclosed subject matter. The identifiers “first” and “second” are not intended to imply any particular order, amount, preference, or importance to the components or steps modified by these terms.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

Reference will now be made in detail to specific aspects of the disclosed materials, compounds, compositions, articles, and methods, examples of which are illustrated in the accompanying Examples and Figures

### Methods

3D printing is driving major innovations in many areas, such as engineering, manufacturing, and medicine. While currently used primarily to manufacture prototypes and small products, recent innovations have provided 3D printing of biocompatible materials, cells, and supporting components on fibrous structures to form complex functional living tissues.

Disclosed herein are methods for printing a three-dimensional fibrous structure that involve printing a fibrous layer onto a printing surface by forcing fibers through at least one extrusion die and onto the printing surface, wherein the extrusion die and/or printing surface are moved in the X, Y, and/or Z direction while printing the fibers. In the disclosed methods, fibers are deposited onto a surface through an extrusion die, as with melt blowing processes for forming nonwoven fabrics. That is, fibers, e.g., biocompatible biomaterials, are extruded through a die (also called nozzels) by high pressure blowing gas. The gas can be ambient or heated gas, and can be air, CO₂, N₂, or other unreactive gas. In the disclosed methods, the location of the fiber deposits is controlled by an X-Y-Z movement system, as are used in 3D printing systems. Such X-Y-Z movement systems can move either the surface that the fibers are being deposited on (printing surface), the extrusion die, or both, such that the fibers deposit in a preselected 3D structure or pattern. The movement can be controlled by one or more computers communicatively connected to the X-Y-Z movement system.

The disclosed methods use a nozzle or die based system to form fibers (a single fiber or a multitude of fibers) in a linear array or a circular array. In other examples, a secondary material may be introduced through the hole in a circular die. The die assembly can be fixed while the printing surface (fiber collection surface) is moved. Based on the polymer processing method, the resulting structure belongs to the ‘meltblown’ category of nonwovens. The disclosed methods are not limited to creating a three-dimensional structure made of a two dimensional fabric but can also create fabrics with local variations in thickness.

In other aspects, the fibers can be forced through more than one extrusion die. Extrusion dies of different shapes can deposit the fibers as different patterns, orientations, or thicknesses. The extrusion dies can be circular, flat, singular capillary. The extrusion die can be a Reicofil die geometry (see U.S. Pat. Nos. 3,650,866 and 3,972,759, which are incorporated by reference herein in their entireties for their teachings of die geometries and melt blowing system components). The extrusion dies can also be a Biax geometry that uses multiple rows of (spinning) orifices with co-centric air supply (see U.S. Pat. No. 5,476,616, which is incorporated by reference herein in its entirety for its teachings of die geometries and melt blowing system components). With this system each fiber is enveloped by a co-centric air supply, allowing more flexibility in terms of shape and arrangement of capillaries than the Reicofil system where fibers are on the same line. Any combinations of these dies can be used. That is, multiple extrusion dies can be used so that different patterns of fibers can be applied to the printing surface, making multiple layers of different patterns. The use of multiple dies, can also permit printing structures of variable thickness, with different properties at different locations, in a single processing step using one or combination of 3D-printing processes.

The fibers that can be used can be natural or synthetic polymers. The fibers can be biocompatible biomaterials. In specific examples, the fibers can be, but are not limited to, poly(glycolic acid) (PGA), poly(lactic acid) (PLA), poly(ε-caprolactone) (PCL), polyurethanes, poly(ortho esters) (POE), poly(anhydrides), polyvinyl alcohol (PVA), tyrosinederived polycarbonates, copolymers thereof, and any combination thereof. In further specific examples, the fibers can be, but are not limited to, collagen, chitosan, fibrin, glycosaminoglycans, silk fibroin, agarose, alginate, starch, gelatin, hyaluronic acid (HA), cellulose, and any combination thereof. In other examples, the fibers can further comprise proteins. Any of these fibers can be used in the form of a melt or a solution.

The disclosed methods can be used to form many different types of fibrous structures. For example, the fibrous structure can be a nonwoven fabric. The fibrous structure can be an article of clothing. The fibrous structure can be a medical bandage, hernia repair plug, vascular graft, knee meniscus, or rotator cuff tendon. The fibrous structure can have a wedge-shaped cross-section and fibers oriented principally in either radial or circumferential direction.

The disclosed methods can also involve forming multiple fibrous layers, e.g., fibers are reapplied to the same area.

### Apparatus

An apparatus for printing a three-dimensional fibrous structure that comprises an extrusion unit comprising at least one extrusion die; a printing platform; an X-Y-Z movement system configured to move the at least one extrusion die and/or the printing platform in a three coordinate system; and at least one computer communicatively coupled with the X-Y-Z movement system, the at least one computer programmed to receive three-dimensional print type inputs for a structure to be three-dimensionally printed and to control the X-Y-Z movement system and extrusion unit.

The extrusion unit can contain more than one extrusion die. The apparatus can also contain a hopper for polymer pellet and a pellet feeding system that is connected to the extrusion unit. A melt pump can pump can be connected to the extruder as well, such that the polymer is forced to and through the extrusion die. This stage of the extrusion unit is akin to a melt blown apparatus. However, unlike standard melt blown apparatuses, where the die assemblies are large (upto several meters), the extrusion dies herein are relatively small, e.g., less than 10 cm, 5, cm, 2 cm, 1 cm, or less. The extrusion unit can also be charged as in an electrospinning device.

The extrusion unit can be a multi-head meltblowing system, which is an aggregate of multiple spun blown heads, which can be individually turned on and off. The spun blown heads have a range of nozzle count, laid out in either square or round pattern, in order to cover a range of resolutions: the smaller nozzle counts for finer details and the large ones for faster coverage. It is also possible to use an annular spunblown die with a particle feeding system in the center. Each head has its own air supply and a melt pump, for controlling fiber diameter and throughput.

Extrusion dies of different shapes can deposit the fibers as different patterns, orientations, or thicknesses. The extrusion dies can be circular, flat, singular capillary. Any combinations of these dies can be used. The extrusion unit can also contain interchangeable dies.

The extrusion unit can be a standard melt blowing apparatus configured to deposit fibers onto a surface (printing surface). The printing surface can be below (under) the extrusion unit, such that the fibers are forced downward onto the printing surface. Alternatively, the extrusion unit can be adjacent to the printing surface such that the fibers are forced laterally on to the printing surface. The extrusion unit can be connected to the X-Y-Z movement system such that the extrusion unit can be moved along the X, Y, and/or Z plains when in use.

The extrusion unit can also be operably connected to a temperature control device to heat the fibers. The extrusion unit can also be operably connected to a pressure control device to control the pressure at which the fibers are forced through the extrusion die.

The printing platform of the apparatus can support the printing surface. The platform can be connected to the X-Y-Z movement system such that the platform can be moved along the X, Y, and/or Z plains when in use.

In some examples, the platform can be perforated and connected to a suction device such that a suction is pulled through the platform. In this way the fibers can be drawn to the printing platform, and thus printing surface, by the suction.

In still other examples, the printing platform can be substantially flat. In other examples, the printing platform can be tubular. In other examples, the printing platform can have 6 degrees of freedom. In other examples, the printing platform can be a preform, which is shaped like a desired article. The preform can be shaped like a portion of a body (e.g., torso, arm, hand, legs, foot, waist, head, etc., or any portion of these). The preform can be shaped like a joint or portion thereof (e.g., rotator cuff, knee meniscus, and the like).

The flat collection system can be a micro-perforated plate mounted on a CNC stage. The X-Y movement control the positioning and orientation of the fiber deposition. The Z axis can be used to set the Die to Collector Distance (DCD) and maintain it, as more layers are added. The microperforations are for the suction. The system works in a similar manner to additive layer printers with the difference that fibers is the material deposited in layers over a controlled area and shape. There is not only control over the local thickness but also on the local fiber orientation. The collection plate could be textured or have relief, to non-flat fabrics.

The tubular or cylindrical collection system can be a rotating micro-perforated collapsible cylinder. The cylinder also moves along its axis, to expose its entire length to the die. The ratio of the translational speed to the rotational speed controls the angle of fiber deposition. Changing the die size allows control of the fiber diameter of a wider range than customary. Selective deposition allows shapes like dumbbell in addition to regular cylinders.

The 6 degrees of freedom collection system can be a robotic arm holding a micro-perforated collapsible three-dimensional shape. This allows the same degree of control and texture as the flat collector but over a spheroid surface. The shape could be a shoe or a bladder (for organ manufacture).

The distance between the extrusion die and the printing surface can be varied, depending on the fibrous structure. Generally, shorter distances result in narrow and thick layers of fibers, whereas longer distances result in broad thin layers of fibers. The force at which the fibers pass through the extrusion die also effects the structure. Generally, high pressures results in broad thin layers of fibers and low pressures results in narrow and thick layers of fibers. The temperature of the extrusion unit or die can be varied to facilitate the printing. The choice of temperature can be made based on the type of fibers being printed. The choice of die can also affect the fibrous structure. Capillary dies offer fine resolution and flat and circular dies offer coarser resolution.

The X-Y-Z movement system can be any system that can move the extrusion unit and/or printing platform in the X, Y, and Z directions. Such systems can be commercially available such as the CNC router type system, a 6 degree of freedom robotic arm, or rotating mandrel. The X-Y-Z movement system can be operably connected to one or more computers that control the movement in the X, Y, and Z directions based on coordinates inputted into the computer.

Referring to FIG. 4, which is a schematic of an apparatus containing a polymer pellet feeding system such as a hopper 1, an extruder 2 connected to a multi-head die assembly 3, which is producing a fiber stream 4 onto a collection system 5.

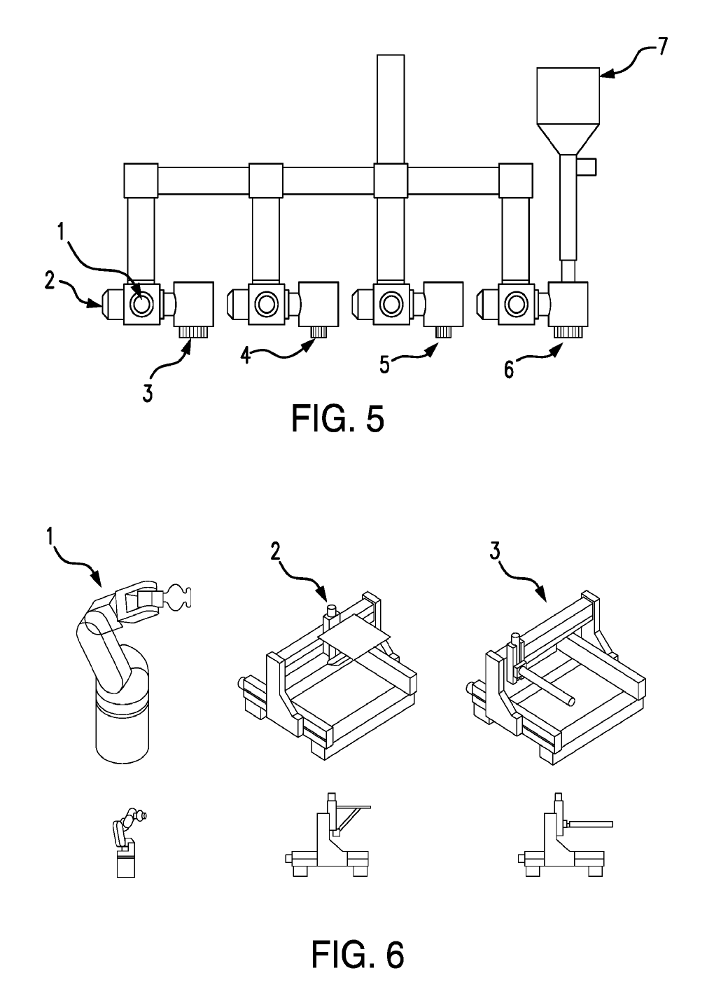

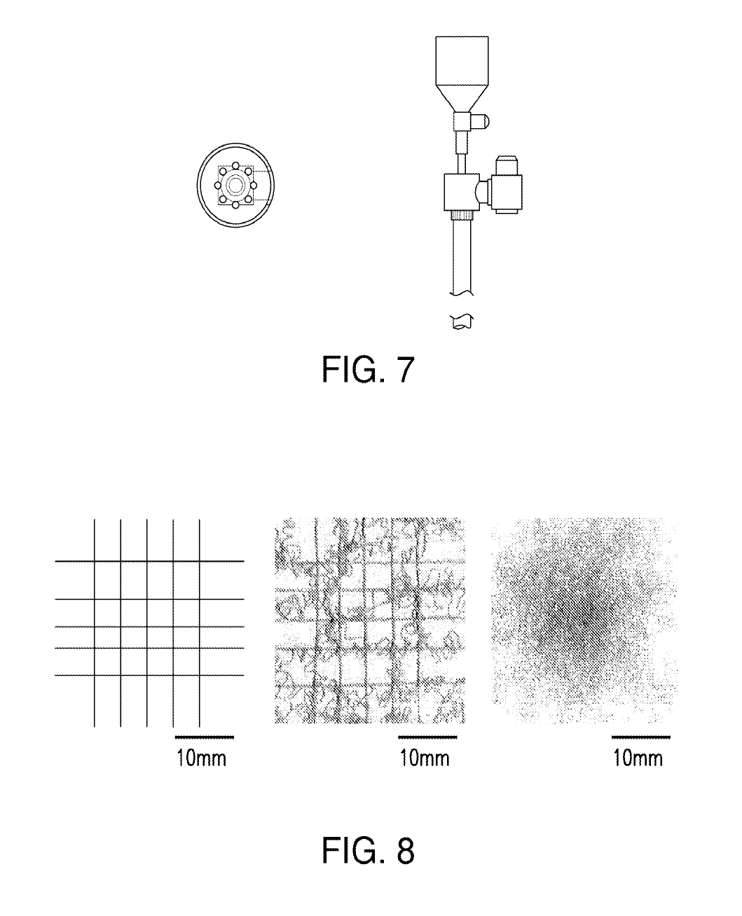

Referring to FIG. 5, details of a multi-head die assembly are shown. For each die, 1 is the polymer flow actuator, 2 is the melt pump, 3 is a high nozzle count, low resolution spinneret, 4 is a medium nozzle count, medium resolution spinneret, and 5 is a low nozzle count, high resolution spinneret. 6 is a hybrid fiber/particle spinneret fed in particles by the hopper 7.

Referring to FIG. 6, the three possibilities for the collection system are illustrated. 1 is the six degrees of freedom collector, 2 is the flat collector, and 3 is the cylindrical collector.

FIG. 8 shows some preliminary web structures, illustrating the control over orientation and layering, done with a single capillary die.

### EXAMPLES

The following examples are set forth below to illustrate the compositions, methods, and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

Prototypes for 3D printing of fibrous materials were developed using a multi-scale melt—and/or—solution blowing system that leads to the formation of a scaffold at high speed and with significant precision. The system uses a meltblowing die with a single capillary for fine resolution and a multi nozzle (flat and circular dies) for coarser resolution. The circular die allows the introduction of a second material (particles, cells, powders, etc.) into the system so that the second component is comingled with the incoming fibers. The prototypes allow the formation of planar pseudo-3D structures as well as true 3D structures using a preform. The system utilizes polymer melts and/or solution. The fiber deposition has an ON and an OFF position and fiber orientation and dimension can be precisely controlled.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for printing a three-dimensional fibrous structure, comprising: printing a fibrous layer onto a printing surface by forcing fibers through at least one extrusion die and onto the printing surface, wherein the extrusion die and/or printing surface are moved in the X, Y, and/or Z direction while printing the fibers.

2. The method of claim 1, wherein fibers are forced through more than one extrusion die.

3. The method of claim 1, wherein the fibers are forced through the extrusion die with pressurized gas.

4. The method of claim 1, wherein the fibers comprise a biocompatible biomaterial.

5. The method of claim 4, wherein the fibers further comprise proteins.

6. The method of claim 1, wherein the fibers are heated polymer fibers.

7. The method of claim 1, wherein the extrusion die is a circular die, a flat die, a singular die, or any combination thereof.

8. The method of claim 1, wherein the fibrous structure has a wedge-shaped cross-section and fibers oriented principally in either radial or circumferential direction.

9. The method of claim 1, wherein the fibrous structure is a medical bandage, hernia repair plug, vascular graft, knee meniscus, or rotator cuff tendon.

10. The method of claim 1, wherein the fibrous structure is a nonwoven fabric.

11. An apparatus for printing a three-dimensional fibrous structure, comprising:
a. an extrusion unit comprising at least one extrusion die;
b. a printing platform;
c. an X-Y-Z movement system configured to move the at least one extrusion die and/or the printing platform in a three coordinate system; and
d. at least one computer communicatively coupled with the X-Y-Z movement system, the at least one computer programmed to receive three-dimensional print type inputs for a structure to be three-dimensionally printed and to control the X-Y-Z movement system and extrusion unit.

12. The apparatus of claim 11, wherein the extrusion unit comprises more than one extrusion die.

13. The apparatus of claim 11, wherein the extrusion unit comprises interchangeable dies.

14. The apparatus of claim 11, wherein the extrusion unit is operably connected to a temperature control device.

15. The apparatus of claim 11, wherein the extrusion unit is operably connected to a pressure control device.

16. The apparatus of claim 11, wherein the printing platform is substantially flat.

17. The apparatus of claim 11, wherein the printing platform is a preform of the three-dimensional fibrous structure.

18. The apparatus of claim 11, wherein the printing platform is perforated and connected to a suction device such that a suction is pulled through the perforation.

19. The apparatus of claim 11, wherein the X-Y-Z movement system is configured to move the at least one extrusion die.
